(19) United States
(12) Patent Application Publication
(10) Pub. No.: US 2024/0323087 A1
(43) Pub. Date: Sep. 26, 2024

(54) GENERATING OPTIMIZED CUSTOM DATA PLANES

(71) Applicant: INTERNATIONAL BUSINESS MACHINES CORPORATION, Armonk, NY (US)

(72) Inventors: Shlomit Koyfman, Qiryat Yam (IL); Ziv Nevo, Yokneam Ilit (IL); Sima Nadler, Kochav Yair (IL)

(21) Appl. No.: 18/125,924

(22) Filed: Mar. 24, 2023

(51) Int. Cl. H04L 41/0894; G06F 8/60; H04L 41/084

(52) U.S. Cl. CPC H04L 41/0894; G06F 8/60; H04L 41/0843

(57) ABSTRACT

System, method and computer program products for generating optimized and customized data planes are provided. In embodiments, a method includes: receiving a data request from a client device in a network, the data request including information regarding one or more governed datasets required by a workload; identifying attributes of available information technology (IT) infrastructure in the network; generating a blueprint of a data plane for the one or more governed datasets using a Constraint Satisfaction Problem (CSP) solver, the blueprint including required software modules for the workload, a subset of the available IT infrastructure to execute the required software modules, and instructions for a flow of data between the required software modules based on predetermined IT configuration policies; and deploying the data plane in the network based on the blueprint, thereby connecting the workload to the one or more governed datasets by the required software modules.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURES: Patel et al., “Fybrik A cloud-native platform to control data usage,” submitted in the Fybrik v1.0 release, Jul. 14, 2022, 2 pages, listed in and provided with IDS; and Patel et al. “Enabling data-plane optimization, submitted in the Fybrik v1.0 release, Jul. 14, 2022, 2 pages, listed in and provided with IDS; Patel et al., “Optimizer,” submitted in the Fybrik v1.1 release, Jul. 14, 2022, 2 pages, listed in and provided with IDS; and Patel et al. “IT Config Policies and Data Plane Optimization, submitted in the Fybrik v1.1 release, Jul. 14, 2022, 8 pages, listed in and provided with IDS.

### BACKGROUND

Aspects of the present invention relate generally to cloud-based data access and governance, and, more particularly, to generating optimized data planes for workload access to datasets.

Various computing tools and methods have been developed to manage the use of data in a cloud-based computing environment. One example is the open solution tool Fybrik, which is a Kubernetes® based cloud-native platform to unify data access, governance and orchestration. Kubernetes® is a registered trademark of The Linux Foundation Non-Profit Corporation. Fybrik aims to reduce the risks of data loss by providing access and use of governed data only via the platform. Before running a workload of a user, an application registers with a Fybrik control plane and provides context about the application (e.g., the purpose for which it is running) and the dataset that the application needs to access. Actions taken by Fybrik are based on policies and the context of the application. In general, Fybrik compiles together relevant inputs into a plotter describing the flow of data between the application and data sources/destinations (data plane). The plotter augments the application workload and data sources with additional services and functions packed as pluggable software modules to create a data path.

### SUMMARY

In a first aspect of the invention, there is a computer-implemented method including: receiving, by a processor set, a data request from a client device in a network, the data request including information regarding one or more governed datasets required by a workload of a user; identifying, by the processor set, attributes of available information technology (IT) infrastructure in the network in response to receiving the data request; generating, by the processor set, a blueprint of a data plane for the one or more governed datasets using a Constraint Satisfaction Problem (CSP) solver, the blueprint including required software modules for the workload, a subset of the available IT infrastructure to execute the required software modules, and instructions for a flow of data between the required software modules based on predetermined IT configuration policies; and deploying, by the processor set, the data plane in the network based on the blueprint, thereby connecting the workload to the one or more governed datasets by the required software modules executed on the subset of the available IT infrastructure.

In another aspect of the invention, there is a computer program product including one or more computer readable storage media having program instructions collectively stored on the one or more computer readable storage media. The program instructions are executable to: receive a data request from a client device in a network, the data request including information regarding one or more governed datasets required by a workload of a user; identify attributes of available information technology (IT) infrastructure in the network in response to receiving the data request; generate a blueprint of a data plane for the one or more governed datasets using a Constraint Satisfaction Problem (CSP) solver, the blueprint including required software modules for the workload, a subset of the available IT infrastructure to execute the required software modules, and instructions for a flow of data between the required software modules based on predetermined IT configuration policies; deploy the data plane in the network based on the blueprint, thereby connecting the workload to the one or more governed datasets by the required software modules executed on the subset of the available IT infrastructure; and send a notification to the client device indicating that the governed data set is available to the workload.

In another aspect of the invention, there is a system including a processor set, one or more computer readable storage media, and program instructions collectively stored on the one or more computer readable storage media. The program instructions are executable to: receive a data request from a client device in a network, the data request including information regarding one or more governed datasets required by a workload of a user; identify available information technology (IT) infrastructure in the network via real-time monitoring of IT infrastructure in the network; identify attributes of the available IT infrastructure in the network; generate a blueprint of an optimized data plane for the one or more governed datasets using an output of a Constraint Satisfaction Problem (CSP) solver, the blueprint including required software modules for the workload, a subset of the available IT infrastructure to execute the required software modules, and instructions for a flow of data between the required software modules based on predetermined IT configuration policies, wherein the CSP solver provides an output based on optimization goals of the IT configuration policies; deploy the optimized data plane in the network based on the blueprint, thereby connecting the workload to the one or more governed datasets by the required software modules executed on the subset of the available IT infrastructure; and send a notification to the client device indicating that the governed data set is available to the workload.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4A depicts an exemplary IT configuration policy defining where data transformations can take place in accordance with aspects of the present invention.

FIG. 4B depicts an exemplary IT configuration policy defining where a read capability will be deployed in accordance with aspects of the present invention.

FIG. 4C depicts an exemplary IT configuration policy allowing implicit copies of data by default in a “read” usage of data, in accordance with aspects of the present invention.

FIG. 5A shows an exemplary JSON structure identifying available infrastructure, which may be accessed by the cloud platform in accordance with aspects of the present invention.

FIG. 5B shows an exemplary JSON structure identifying attributes of the available infrastructure, which may be accessed by the cloud platform in accordance with aspects of the present invention.

FIG. 6A illustrates a chain type data plane blueprint including a chain of software modules linking a dataset to a workload in accordance with aspects of the present invention.

FIG. 6B illustrates the matrix type data plane blueprint including a matrix of software modules providing data paths between datasets and a workload in accordance with aspects of the present invention.

FIG. 7 depicts an exemplary use scenario in accordance with implementations of the invention.

### DETAILED DESCRIPTION

Aspects of the present invention relate to cloud-based data access and governance, and, more particularly, to generating optimized and customized data planes for workload access to governed datasets. Embodiments of the invention provide methods, computer program products, and systems to generate optimized and customized data planes for workloads (e.g., of applications) in a cloud-based environment, which consider available IT resources/infrastructure, application specifications, specifications of the datasets required by the workloads, governance actions required by data-governance policies, and information technology (IT) policies.

In general, the term data plane refers to a part of a computer network through which data packets are transmitted. The term workload as used herein refers to an amount of computing resources and time it takes to complete a task or generate an outcome. Any application or program running on a computer can be considered a workload. In implementations of the invention, a data plane comprises a chain or matrix of pluggable software modules implemented on IT infrastructure and connecting a workload to at least one governed dataset required by the workload.

Enabling the use of data in a secure and governed manner in a multi-cloud environment is challenging. It is even more challenging to enable use of the data in a manner that optimizes the utilization of available infrastructure in different environments (e.g., computing clusters) within the multi-cloud environment. Laws, industry standards, and organization policies dictate how, by whom, where, and for what, data may be used based on a specific context, such as the content of the dataset at issue and the purpose for which the dataset will be used. In some cases, policies dictate how data should be transformed before use. How the data may be utilized can also depend on available infrastructure, and policies may take into consideration the costs for performing different capabilities within a data plane, and where (e.g., which geographic location or computing cluster) resources should be deployed.

Manual processes have been developed to address problems associated with the secure use of data. In one example, a user requests data, and the request is manually reviewed by a data governance officer who may approve the request, deny the request, or provide guidance regarding required data transformations. In this example, an IT administrator may copy and transform the data, and provide an endpoint and credentials to the user who uses the data.

Infrastructure and tools for these tasks may be manually chosen based on infrastructure availability, cost and organization guidelines. Upon completion of the use of the data, the user or IT administrator is responsible for deleting any temporary copy of the data generated in response to the user's request for data.

Computing tools exist to do parts of the above-listed tasks, but there is no end-to-end automated mechanism that orchestrates the entire process and forms a customized data plane. For example, Extract, Transform and Load (ETL) tools such as DataStage® (a registered trademark of International Business Machine Corporation) and Jaspersoft® (a registered trademark of TIBCO Software Inc.) enable jobs to be written to copy and data to be transformed, but require jobs to be written manually for each dataset requested by a network user, and do not handle cleanup of the copied data after it is no longer needed.

Implementations of the invention provide methods for declaring the availability of infrastructure and its attributes and defining IT configuration policies which may dictate: (a) which capabilities may, should or should not be included in a given data path based on metadata of a governed dataset and the data request context; (b) where capabilities should be deployed, such as which cluster of computing devices or in which geographic location; and (c) which type of capability implementation should be chosen, such as deploy per workload or multi-tenant implementations. Additionally, embodiments of the invention provide methods for determining an optimal customized data plane for a dataset of interest based on: (a) dataset metadata; (b) context of a request; (c) data governance decisions; (d) configuration policy decisions; and (e) attributes of available infrastructure. Further, aspects of the invention provide methods for determining the optimal customized data planes for all datasets used by a given workload, and methods for optimizing custom data planes across multiple workloads.

Embodiments of the invention build an optimized custom data plane to bring governed data to end-user workloads, while complying with governance rules and adhering to IT policies affecting infrastructure usage, including optimization goals. In embodiments, the optimized custom data plane comprises software modules to transfer and transform the governed data. Certain implementations of the invention constitute an improvement to a Fybrik control plane, by providing new optimization functions enabling the on-demand automated generation of optimized custom data planes in a cloud-based computing environment.

In aspects of the invention, for each end-user request to use governed datasets, a method includes the following steps. First, a cloud platform compiles a Constraint Satisfaction Problem (CSP), which considers all relevant inputs (e.g., dataset metadata, data governance rules, available infrastructure, available software modules, IT policies, and IT optimization goals). Every assignment to the CSP's variables is a possible data plane, where rules and policies translate to constraints on the data plane, and where optimization goals are translated to minimizing the value of specific integer variables. Second, the cloud platform runs a CSP solver to find an optimal solution, and translate the solution into a data plane blueprint, specifying which software modules to run, where to run the software modules, and how to run the software modules. Finally, the cloud platform uses the blueprint to configure, deploy and connect required software modules, using specified infrastructure, thereby generating an optimized custom data plane. With this optimized custom data plane, required data may be routed to the user workload while complying with predetermined policies.

Advantageously, implementations of the invention address technical problems associated with governing data use in a cloud-based environment by reducing consumption of computing resources through optimization of a data plane. For example, optimization goals may lead a cloud platform to select IT infrastructure in the same geographic location as a workload, thereby reducing processing time. Additionally, embodiments of the invention provide a technical solution enabling a user to customize optimization goals within IT configuration policies, whereby a custom data plane (e.g., in the form of interconnected select software modules) is automatically generated on-demand in response to a data request and in accordance with the IT configuration policies, wherein the custom data plane enables a workload to access required datasets in a network environment.

Implementations of the invention are necessarily rooted in computer technology. For example, deploying an optimized custom data plane in a computer network environment is computer-based and cannot be performed in the human mind. Moreover, the generation of a data plane blueprint and deployment of an optimized custom data plane in accordance with embodiments of the invention is a technical solution to a technical problem arising in the field of computer networks (e.g., enabling network users access to remotely stored data in compliance with data governance rules/policies). The term data plane blueprint as used herein refers to a set of instructions for connecting a workload to one or more governed datasets using required software modules executing on available IT infrastructure according to IT configuration and data governance policies.

It should be understood that, to the extent implementations of the invention collect, store, or employ personal information provided by, or obtained from, individuals (for example, user credentials), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Data Plane Optimization Code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

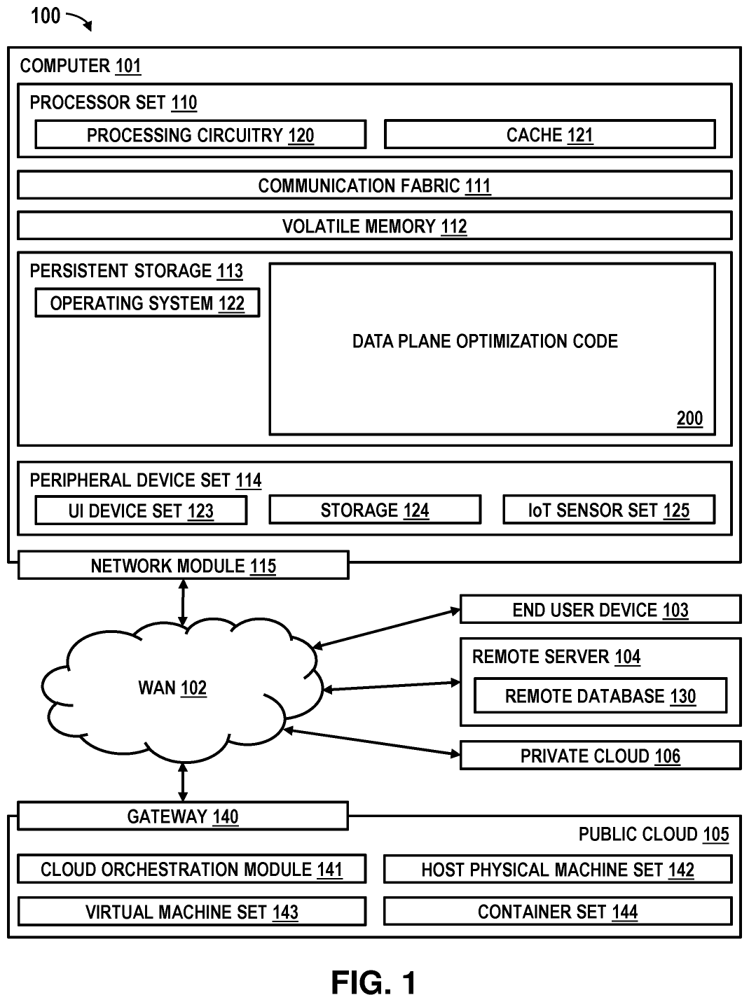

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

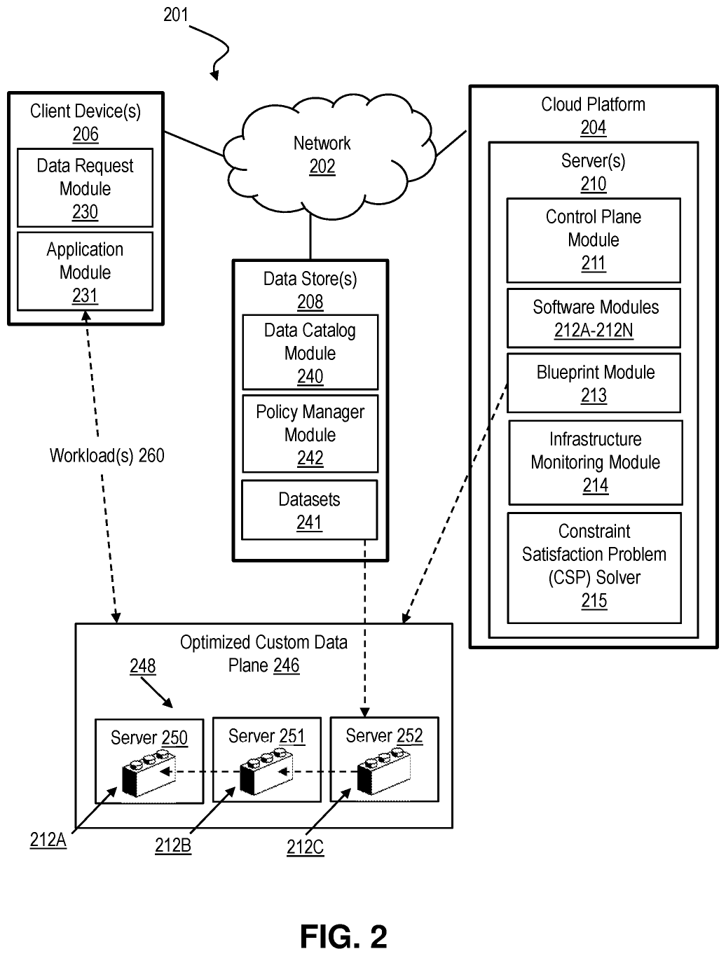

FIG. 2 shows a block diagram of an exemplary environment 201 in accordance with aspects of the invention. In embodiments, the environment 201 includes a cloud platform 204 in communication with one or more client devices 206 and data stores 208 via the network 202. In implementations, the cloud platform 204 comprises a set of processors implemented in one or more servers 210.

In embodiments, the cloud platform 204 of FIG. 2 comprises software modules (modules), each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. In aspects of the invention, the cloud platform 204 comprises a cloud-native platform to unify data access, governance and orchestration. In aspects, the cloud platform 204 comprises an improved Fybrik platform configured to perform new data plane customization and optimization methods discussed herein.

The one or more servers 210 may be in the form of the computer 101 of FIG. 1, and may utilize the processor set 110 to initiate software code (e.g., 200 of FIG. 1) that executes method steps described herein. In embodiments, the one or more servers 210 include one or more of the following modules: a control plane module 211 configured to implement method steps described herein to generate customized and optimized data planes; software modules 212A-212N configured to perform functions associated with a workload; a blueprint module 213 configured to manage one or more data plane blueprints generated by the control plane module 211; and an infrastructure monitoring module 214 configured to monitor computing resources (i.e., IT infrastructure) in the environment 201 and store attributes of the computing resources. In implementations, the software modules 212A-212N are pluggable modules (i.e., stand-alone modules that can be launched by a framework or other application, and run independent of the launching application).

In implementations, the one or more servers 210 further include a Constraint Satisfaction Problem (CSP) solver 215 configured to solve CSPs in accordance with method steps discussed herein. In general, CSPs are mathematical questions defined as a set of objects whose state must satisfy a number of constraints or limitations. The term CSP solver refers to a library designed to provide the functionalities to solve CPSs without the need to write specific software code to do so.

In embodiments, the one or more client devices 206 are in the form of the end user device 103 of FIG. 1. In implementations, the one or more client devices 206 include one or more of the following modules: a data request module 230 configured to generate and send data requests to the cloud platform 204, and an application module 231 configured to perform software encoded functions utilizing datasets accessed via the cloud platform 204.

In embodiments, the one or more data stores 208 are in the form of the remote server 104 of FIG. 1. In implementations, the one or more data stores 208 include one or more of the following modules: a data catalog module 240 configured to store information regarding stored governed datasets 241; and a policy manager module 242 configured to store policies (e.g., data governance policies) regarding the stored governed datasets 241.

In implementations, the cloud platform 204 automatically generates an optimized custom data plane 246 including a chain or matrix 248 of required software modules (e.g., modules 212A-212C) executed by IT resources (i.e., available IT infrastructure) represented by the servers 250-252. In embodiments, the optimized custom data plane 246 is automatically generated on-demand based on a data request received from the one or more client devices 206. In implementations, the optimized custom data plane 246 controls a path or paths of data between the required software modules (e.g., 212A-212C) to connect the stored governed datasets 241 to a workload 260 (e.g., of application module 231) in response to a request for data sent to the cloud platform 204. In implementations a workload 260 is associated with a cluster of computing resources at a geographic location, and the optimized custom data plane 246 is associated with the same or different cluster of computing resources (e.g., a cluster at that same or a different geographic location).

The cloud platform 204, the one or more client devices 206, and the one or more data stores 208, may each include additional or fewer modules than those shown in FIG. 2. In embodiments, separate modules may be integrated into a single module. Additionally, or alternatively, a single module may be implemented as multiple modules. Moreover, the quantity of devices and/or networks in the environment 201 is not limited to what is shown in FIG. 2. In practice, the environment 201 may include additional devices and/or networks; fewer devices and/or networks; different devices and/or networks; or differently arranged devices and/or networks than illustrated in FIG. 2.

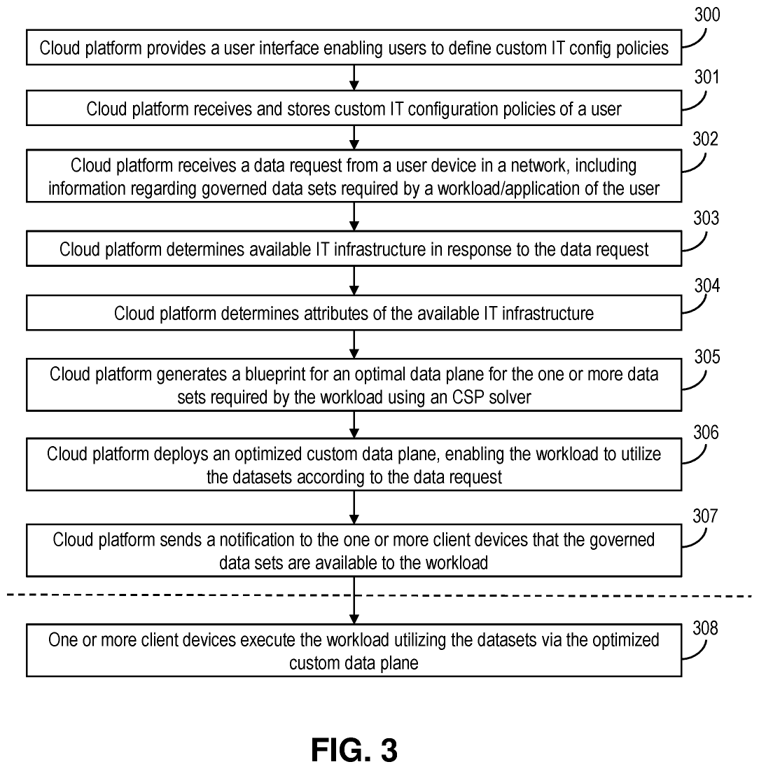

FIG. 3 shows a flowchart of an exemplary method in accordance with aspects of the present invention. Steps of the method may be carried out in the environment 201 of FIG. 2 and are described with reference to elements depicted in FIG. 2. In aspects, the cloud platform 204 includes one or more computer readable storage media having program instructions collectively stored on the one or more computer readable storage media, wherein the program instructions are executable to perform one or more of the following steps.

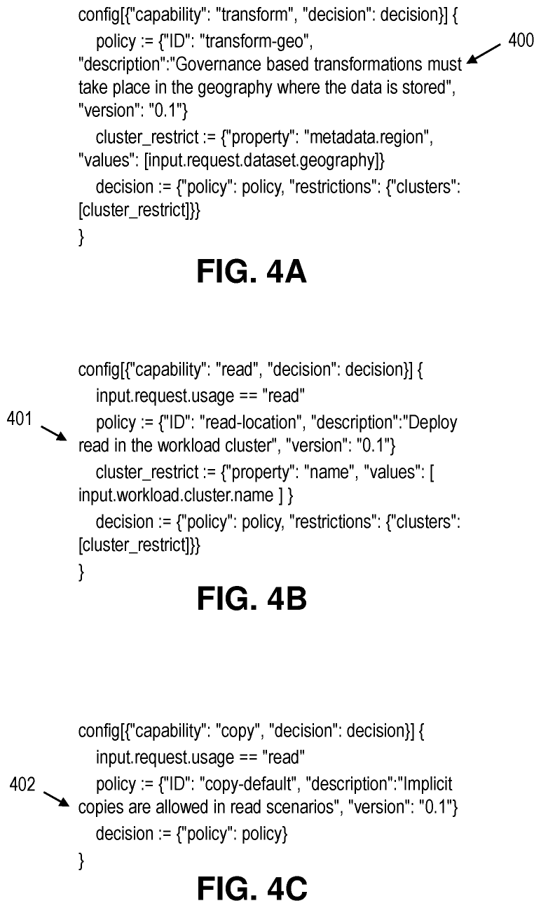

At step 300, the cloud platform 204 provides a user interface enabling users to define custom Information Technology (IT) configuration policies for a set of computer resources. In general, IT configuration policies or IT config policies are the mechanism via which an organization may influence the construction of a data plane, taking into account infrastructure capabilities and costs. IT configuration policies may influence what capabilities or actions should be deployed/allowed (e.g., read, copy), in which cluster(s) or location(s) of computing resources they should be deployed/utilized, and the selection of the most appropriate software module(s) (e.g., 212A-212C) that implement the capabilities. In one example, an IT configuration policy restricts the choice of clusters of computing resources and software modules 212A-212N for a read capability by narrowing the choice of deployment clusters to the same location as the workload cluster, and restricts the software module type to a service type. In embodiments, the control plane module 211 of the cloud platform 204 provides the user interface to the one or more client devices 206. Examples of IT configuration policies are depicted in FIG. 4A-4C, discussed below.

At step 301, the cloud platform 204 optionally receives and stores custom (user-defined) IT configuration policies received via the user interface provided at step 300. In implementations, the customized IT configuration policies include user-defined optimization goals. For example, a customized IT configuration policy may include a rule that a resource having an external storage cost exceeding $100 may not be used. In embodiments, the control plane module 211 receives and stores the custom IT configuration policies from a client device 206. In alternative embodiments, the cloud platform 204 accesses stored default IT configuration policies.

At step 302, the cloud platform 204 receives a data request from a user (e.g., a client device 206) in the environment 201 including context information regarding one or more governed datasets required by a workload or software application (e.g., application module 231). In implementations, the control plane module 211 of the cloud platform 204 receives the data request from a data request module 230 of a client device 206.

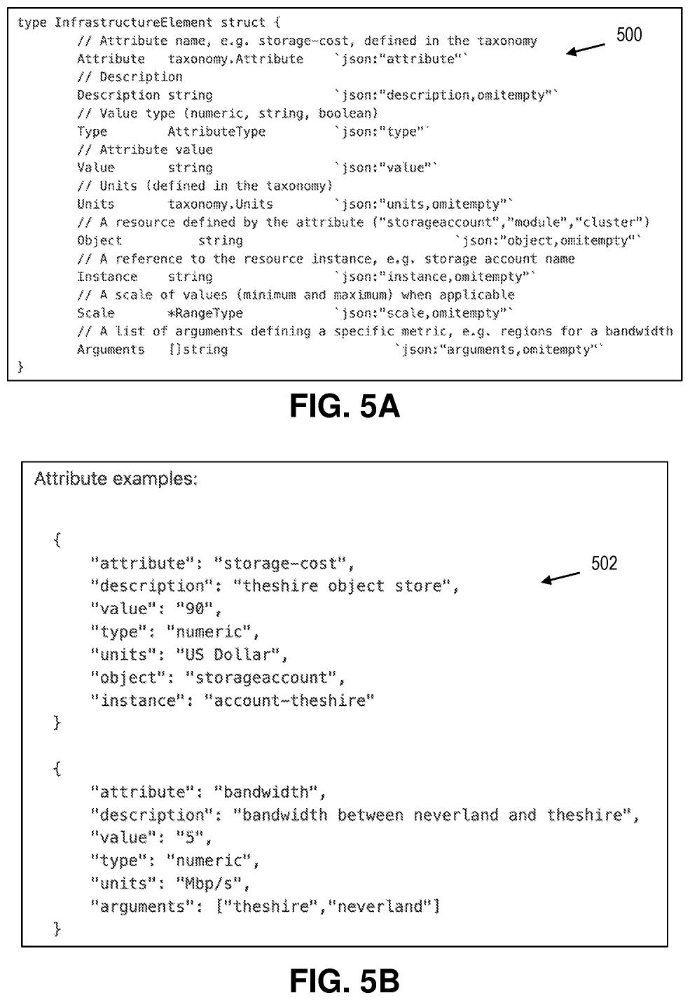

At step 303, the cloud platform 204 determines available IT infrastructure or IT resources (e.g., servers 250-252) within the environment 201 (e.g., multi-cloud environment) to utilize in response to receiving the user request. In embodiments, in order to determine where to deploy the different services or jobs of the workload in a data plane, the cloud platform 204 determines what infrastructure exists or is available (e.g., clusters, storage, central processing units (CPUs), graphics processing units (GPUs), etc.). In implementations, the cloud platform 204 accesses information stored in a JavaScript Object Notation (JSON) structure, which can be updated manually or via automated processes that monitor the infrastructure of a network environment. JSON structure is a standard text-based format for representing structured data based on JavaScript object syntax. In implementations, the infrastructure monitoring module 214 of the cloud platform 204 monitors (e.g., in real time) IT resources of the environment 201 for availability of the IT resources, and stores the information in the JSON structure for access by the cloud platform 204 at step 303. An example of JSON structure identifying available IT infrastructure is shown in FIG. 5A, discussed below.

At step 304, the cloud platform 204 determines attributes of the available IT infrastructure. In implementations, the infrastructure monitoring module 214 of the cloud platform 204 monitors computing resources of the cloud platform 204, including attributes of the resources, and stores the information in the JSON structure. An example of JSON structure identifying infrastructure attributes is shown in FIG. 5B, discussed below.

At step 305, the cloud platform 204 generates a blueprint for an optimal data plane for the one or more governed datasets using the CSP solver 215, wherein the blueprint for the optimal data plane includes a chain or matrix 248 of required software modules (e.g., software modules 212A-212C) connecting the workload 260 to at least one of the governed datasets 241 it requires. In implementations, each software module utilized in a data plane is configured to perform a unique function/action or set of functions/actions. For example, one or more of the required software modules may perform data transformations required to keep raw data private in accordance with data governance policies/rules.

In embodiments, the CSP solver 215 is executed to output an optimal solution including best-fit IT infrastructure of the available IT infrastructure, and required software modules (e.g., 212A-212C) in terms of pre-defined optimization policies in the IT configuration policies (custom or default). In implementations, the CSP solver 215 considers the following input parameters/variables: the available IT infrastructure determined at step 304, the available software modules 212A-212N and their capabilities (based on information stored in the cloud platform 204), the IT configuration policies (customized or default), and stored data governance policies of the one or more governed datasets 241.

In general, data governance is a system of decision rights and accountabilities for information-related processes, executed according to agreed-upon data governance policies (e.g., models) which describe who can take what actions with what information, and when, under what circumstances, using what methods. The CSP solver 215 may obtain data governance policies stored on the cloud platform 204 or may obtain remotely stored data governance policies (e.g., from policy manager module 242). In implementations, the term data governance policies as used herein includes instructions for governed datasets regarding who can take what actions with what information, when the actions can be taken, under what circumstances the actions can be taken, and what methods may be used for taking the actions. In one example, data governance policies require one or more data transformations before a user application may access the data to keep raw data private.

In embodiments, the cloud platform 204 translates a CSP optimal solution of available IT resources and software modules into a blueprint for a data plane (i.e., a data plane blueprint). In implementations, the data plane blueprint specifies the required software modules to run (e.g., 212A-212C), where to run/execute the software modules (e.g., on which of the best-fit IT infrastructure to run each of the required software modules), and instructions regarding how to run the required software modules (e.g., the order of tasks/functions and flow of data between software modules).

In embodiments, the blueprint comprises a linear flow of data through a chain of interconnected software modules. In a first CSP method, the cloud platform 204 considers the data plane to include a chain of software modules (e.g., 212A-212C) of length n, connecting the workload 260 to one of the datasets 241 the workload 260 requires. In the example of FIG. 2, required software modules 212A-212C are run on respective servers 250-252 with data flowing linearly from the server 252 to the server 250. For this first CSP method, the cloud platform 204 allocates the following set of CSP variables for each location (e.g., available software module) in the chain: (1) the software module (e.g., 212A) and its capability to be used at the location (integer); (2) governance actions for the software module to execute (e.g., Boolean per action); (3) a compute cluster (IT infrastructure) where the module will run (integer); (4) external storage for the software module to store its output (integer); and (5) an interface (e.g., protocol and data format) to be used in the software module's input/output (2 integers).

For this first CSP method, the cloud platform 204 may set the following additional constraints: (1) each governance action required by the governance policies must be handled by exactly one available software module (e.g., 212A) that supports it; (2) the output interface (e.g., protocol and data format) of a software module matches the input interface of its following software module (e.g., 212B); and (3) IT configuration policies are followed (e.g., external storage with cost >$100 must not be used). The first CSP method further requires the cloud platform 204 to instruct the CSP solver 215 to provide solutions that minimize a set of additional variables derived from the optimization policies (e.g., optimization goals) of the IT configuration policies (customized or default). For example, an optimization goal may require a cost variable to sum the costs of all storage resources used to meet customized IT configuration policies regarding cost limits.

The first CSP method starts with a software module chain of length 1, and iteratively increases the length of the software module chain. For each length (e.g., software module) in the software module chain, a CSP model is created, and the CSP solver is called by the cloud platform 204 to generate a solution (including a suggested software module). The solutions are scored/rated for optimization, and the solution with the best score/rating with respect to the optimization goal is selected by the cloud platform 204 for a location in the software module chain. An example of a chain type data plane blueprint is depicted in FIG. 5A, discussed below.

The approach of the first CSP method can be generalized to non-linear data planes. In implementations, the blueprint comprises a non-linear flow of data through a matrix of interconnected required software modules, wherein at least one of the required software modules in the blueprint performs more than one governed action during execution of the workload 260. For example, grid topologies may be considered, allowing diverging and converging data paths. Accordingly, a second non-linear CSP method may be utilized by the cloud platform 204. In this second CSP method, CSP parameters/variables define connectivity between available software modules (i.e., which software module talks to which other software module(s)) within an m×n matrix or grid of software modules). In general, an m×n matrix is an ordered rectangular array of elements containing m rows and n columns, wherein each matrix element is given two indices; the first identifying the row and the second identifying the column. This second CSP method enables the reuse of a software module in multiple data paths (wherein not all locations in the matrix or grid must be assigned with software modules). An example of a matrix type data plane blueprint is depicted in FIG. 5B, discussed below.

In the second CSP method, a fully-connected grid is used as the data-plane model given to the CSP solver 215. The data plane model represents all degrees of freedom from which the CSP solver selects which grid cells to populate with which software modules and how to connect the software modules. In a similar third CSP method, multiple workloads 260 are included on the right hand side of the grid. In such cases, the grid may have more lines to allow additional paths from datasets to the workloads 260.

With continued reference to FIG. 3, at step 306, the cloud platform 204 deploys an optimized custom data plane 246 based on the data plane blueprint. In implementations, the cloud platform 204 configures, deploys and connects the required software modules (e.g., 212A-212C) in the data plane blueprint using the best-fit IT infrastructure (e.g., servers 250-252), thus enabling the workload 260 to utilize the required datasets in accordance with the data request received at step 302. It can be understood that choosing a best-fit IT infrastructure with respect to optimization goals of a user can reduce the financial cost of data usage as well as the computational costs, thus providing an optimized custom data usage experience for the user.

At step 307, the cloud platform 204 sends a notification to the one or more client devices 206 indicating that the one or more governed datasets are available to the workload 260 (via the optimized custom data plane 246).

At step 308, one or more client devices 206 execute the workload 260 utilizing the datasets via the optimized custom data plane 246 (e.g., in response to receiving the notification of step 307).

FIG. 4A depicts an exemplary IT configuration policy defining where data transformations can take place in accordance with aspects of the present invention. In the example of FIG. 4A, governance based transformations of data must take place in the geographic location where the data is being stored, as indicated at 400.

FIG. 4B depicts an exemplary IT configuration policy defining where a read capability will be deployed in accordance with aspects of the present invention. In one example, the read location is in the workload cluster, as indicated at 401.

FIG. 4C depicts an exemplary IT configuration policy allowing implicit copies of data by default in a “read” usage of data, in accordance with aspects of the present invention. In one example, the copies of data are allowed in read scenarios, as indicated at 402.

FIG. 5A shows an exemplary JSON structure identifying available infrastructure, which may be accessed by the cloud platform 204 at step 303 of FIG. 3, in accordance with aspects of the present invention. In this example, information regarding available infrastructures is depicted at 500 in FIG. 4A.

FIG. 5B shows an exemplary JSON structure identifying attributes of the available infrastructure, which may be accessed by the cloud platform 204 at step 304 of FIG. 3, in accordance with aspects of the present invention. In this example, information regarding attributes of infrastructure is depicted at 502 in FIG. 4B. Attributes may include costs associated with certain services and available bandwidth, for example.

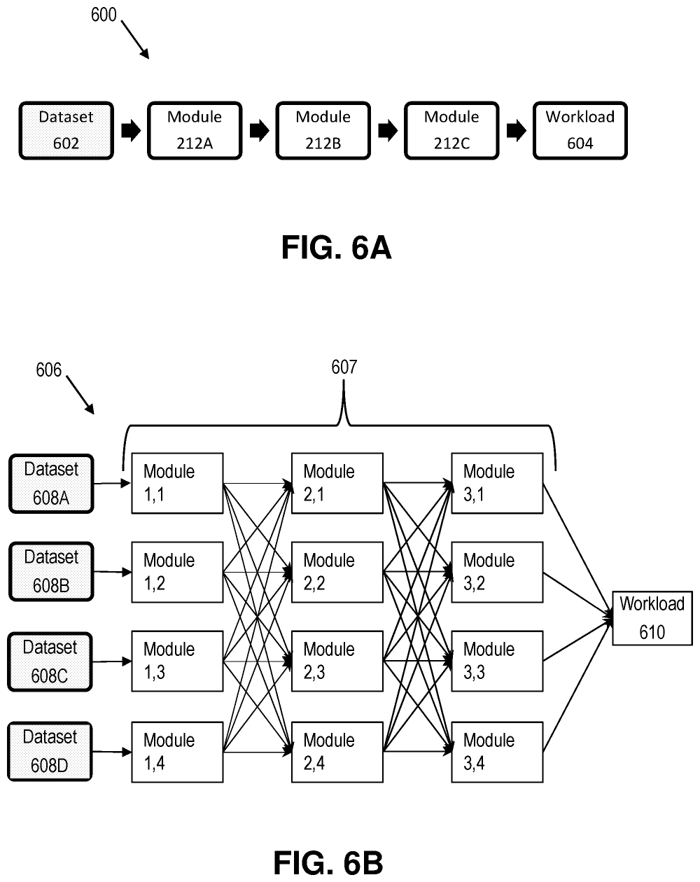

FIG. 6A illustrates a chain type data plane blueprint 600 including a chain of software modules 212A, 212B and 212C linking a dataset 602 to a workload 604, in accordance with aspects of the present invention. The first data chain blueprint 600 may be generated in accordance with FIG. 4 in the environment 201 of FIG. 2.

FIG. 6B illustrates a matrix type data plane blueprint 606 including a matrix 607 of software modules providing data paths between datasets 608A-608D and a workload 610, in accordance with aspects of the present invention. The matrix type blueprint 606 may be generated in accordance with FIG. 3 in the environment 201 of FIG. 2. In this example, multiple software modules (e.g., module 2, 1; module 2, 2; etc.) perform actions/functions for more than one previous module (e.g., module 1,1; 1, 2; etc.) in a data flow direction within the matrix 607 of software modules. Although not depicted, in embodiments where there are multiple workloads (i.e., the third CSP method discussed above), additional lines may be added to the matrix of FIG. 6B to interconnect the matrix 607 to multiple workloads (e.g., including workload 610) on the right hand side of the FIG. 6B diagram.

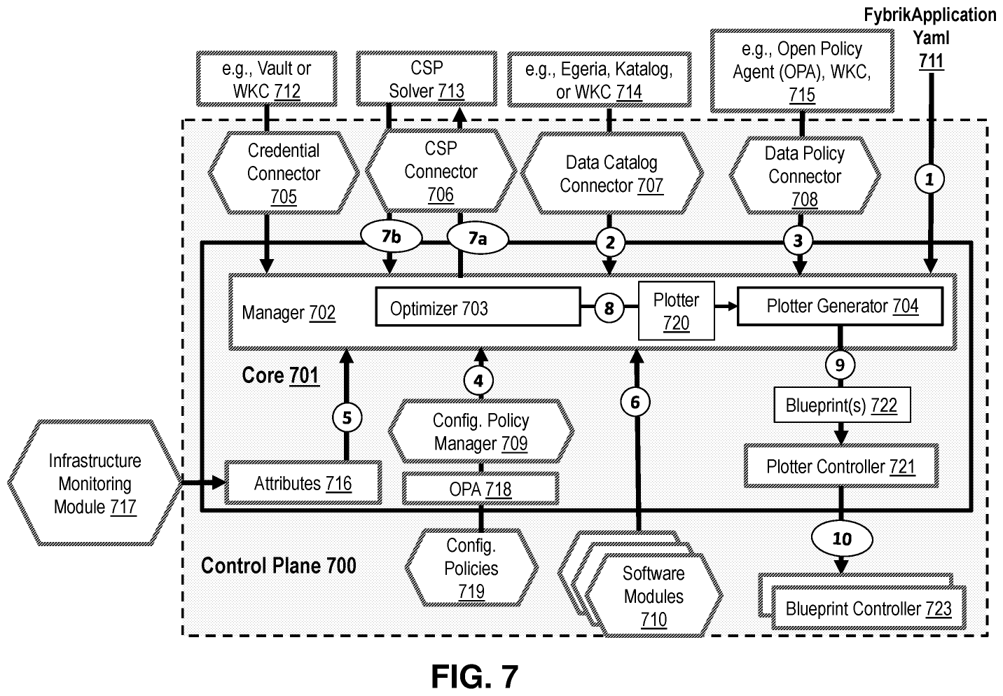

FIG. 7 depicts an exemplary use scenario in accordance with implementations of the invention. FIG. 7 references elements of FIG. 3, and may be implemented in the environment 201 of FIG. 2. The exemplary embodiment of FIG. 7 is implemented as an improved Fybrik control plane 700 (which may comprise the control plane module 211 of FIG. 2).

In implementations, the control plane 700 includes a core 701 having a manager 702 controlling an optimizer 703 and a plotter generator 704 (which may comprise the blueprint module 213 of FIG. 2). In implementations, the manager 702 is configured to obtain data from multiple data sources of the control plane 700, via a credential connector 705, a CSP connector 706, a data catalog connector 707, a data policy connector 708, a configuration policy manager 709, and available software modules 710 (which may comprise the software modules 212A-212N of FIG. 2).

Additionally, the manager 702 obtains information regarding which datasets should be used and for what purpose the datasets will be used (e.g., a data request) from a user interface represented by FybrikApplicationYAML711. YAML (Yet Another Markup Language) is a data serialization language used as the input format for diverse software applications. In implementations the software modules 710 or a module repository they are housed in, provide information regarding capabilities of each of the software modules 710 to the manager 702. In implementations, one or more of the software modules 710 is configured to perform actions to enforce data governance policies, such as masking or redacting data.

In embodiments, the connectors of FIG. 7 connect the control plane 700 to external services to receive data governance decision, metadata about datasets and credentials. In the example of FIG. 7, the credential connector 705 is adapted to receive user credentials from a credential vault 712, such as Watson Knowledge Catalog (WKC). Additionally, the CSP connector 706 is configured to access and utilize a CSP solver 713 (e.g., CSP solver 215 of FIG. 2). In this example, the data catalog connector 707 is configured to access one or more data catalogs 714 such as Egeria®, Katalog (a built-in catalog of Fybrik), and WKC. Egeria® is a registered trademark of ODPI, Inc. and provides an open metadata and governance platform for enterprises. The one or more data catalogs 714 may comprise the data catalog module 240 of FIG. 2. The example of FIG. 7 also shows the data policy connector 708 configured to access a source of data policies 715, such as WKC and/or a remote open policy agent (OPA), which is an open source, general-purpose policy engine that unifies policy enforcement. The source of data policies 715 may comprise the policy manager module 242 of FIG. 2, for example.

In embodiments, the core 701 obtains information about attributes of available IT infrastructure or resources from attributes store 716, which may be generated by an infrastructure monitoring module 717 (e.g., the infrastructure monitoring module 214 of FIG. 2). In implementations, the configuration policy manager 709 obtains configuration policies from an internal open policy agent (OPA) 718, which accesses stored configuration policies 719.

In aspects of the invention, the plotter generator 704 is instructed what software modules need to be installed, and where (i.e., on which available IT resources) by the optimizer 703, and generates a plotter 720 specifying a data plane connecting the workload(s) at issue to the datasets it requires. In embodiments, the plotter 720 lists the software modules 710 to be used, the capabilities required from these software modules 710, the cluster on which each of the software modules 710 should be deployed, as well as a flow of data between the dataset at issue and the workload through the chosen software modules. In the example of FIG. 7, the plotter 720 is sent by the optimizer 703 to the plotter generator 704 which generates a blueprint 722 of a data plane, and sends the blueprint 722 to the plotter controller 721, which sends the blueprint 722 to a blueprint controller 723. In aspects of the invention the blueprint controller 723 is configured to deploy an optimized custom data plane (e.g., 246 of FIG. 2) based on the blueprint 722, wherein the custom data plane complies with IT configuration and data governance policies particular to the requested datasets and the needs of the workload(s). In implementations, one or more connectors of FIG. 7 can be combined, and/or all or some of the sources of data 712-715 may be combined into a single source of data.

An exemplary use scenario will now be discussed with respect to FIG. 7. At step 1, a user specifies a workload(s) to deploy and the datasets it needs to use, in the form of a data request. At step 2, the manager 702 retrieves metadata of the datasets of step 1 from one or more data catalogs 714 (e.g., WKC) via the data catalog connector 707. At step 3, the manager 702 retrieves constraints on data usage from the source of data policies 715 (e.g., WKC) via the data policy connector 708. At step 4, the manager 702 retrieves constraints on deploying software modules 710, as well as optimization goals, based on IT policies from the source of configuration policies 719 via the configuration policy manager 709 and the OPA 718. In embodiments, the OPA 718 translates policies from the configuration policies 719 into constraints for use by the CSP solver 713. At step 5, the manager 702 retrieves available infrastructure and the attributes of the available infrastructure from the attributes store 716. At step 6, the manager 702 retrieves a list of available software modules from the software modules 710 or a store of the software modules 710. At step 7a, the manager 702 compiles the data retrieved at steps 1-6 into a Constraint Satisfaction Problem (CSP), and sends the CSP to the CSP solver 713 via the CSP connector 706. At step 7b, the manager 702 obtains an output of the CSP solver 713 via the CSP connector 706 in the form of an optimal solution to the CSP. At step 8, the optimizer 703 of the manager 702 translates the optimal solution into a data plane plotter 720. At step 9, the plotter generator 704 of the manager 702 translates the data plane plotter 720 into one or more blueprints 722, wherein each blueprint 722 specifies the software modules 710 to be deployed and how the software modules 710 will connect the flow of data, in the context of a single computing cluster (e.g., servers 250-252 of FIG. 2). At step 10, the blueprint controller 723 obtains the blueprint(s) 722 from the plotter controller 721, and manages the deployment of the software modules 710 in one or more data planes (e.g., optimized custom data plane 246 of FIG. 2) according to the blueprint(s) 722 it receives.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, a data request from a client device in a network, the data request including information regarding one or more governed datasets required by a workload of a user;
identifying, by the processor set, attributes of available information technology (IT) infrastructure in the network in response to receiving the data request;
generating, by the processor set, a blueprint of a data plane for the one or more governed datasets using a Constraint Satisfaction Problem (CSP) solver, the blueprint including required software modules for the workload, a subset of the available IT infrastructure to execute the required software modules, and instructions for a flow of data between the required software modules based on predetermined IT configuration policies; and
deploying, by the processor set, the data plane in the network based on the blueprint, thereby connecting the workload to the one or more governed datasets by the required software modules executed on the subset of the available IT infrastructure.

2. The method of claim 1, wherein one or more of the required software modules of the data plane is configured to perform data transformations of the one or more governed datasets based on predetermined data governance policies.

3. The method of claim 1, further comprising:
providing, by the processor set, a user interface enabling a user to define custom information technology (IT) configuration policies for a set of computer resources in a network; and
receiving and storing, by the processor set, custom IT configuration policies of the user indicating what computing capabilities to allow, what computing resources to deploy, and what set of software modules to use to implement the computing capabilities, wherein the predetermined IT configuration policies are the custom IT configuration policies, and the data plane is a custom data plane deployed in accordance with the custom IT configuration policies.

4. The method of claim 1, further comprising monitoring, by the processor set, IT infrastructure in the network in real time to identify the available IT infrastructure.

5. The method of claim 1, wherein the attributes of the available IT infrastructure include storage costs and bandwidth capacity.

6. The method of claim 1, wherein the generating the blueprint of the data plane comprises inputting, by the processor set, parameters to the CSP solver including: the available IT infrastructure, available software modules; capabilities of the available software modules; the predetermined IT configuration policies; and stored data governance policies for governance actions to be taken with respect to the one or more governed datasets.

7. The method of claim 6, further comprising allocating, by the processor set, a set of constraint variables for each location in a chain of the required software modules, the set of constraint variables including: an integer for each of the required software modules; an integer for each capability of each of the required software modules to be utilized at each of the locations in the chain; a Boolean per governance action executed by each of the required software modules at each of the locations in the chain; an integer per computational cluster of IT infrastructure where each of the required software modules will run; an integer for each external data storage location storing an output of each of the required software modules; and two integers for each interface configuration to be used in each of the required software modules input and output, wherein the blueprint comprises a linear flow of data through a chain of the required software modules.

8. The method of claim 6, wherein the generating the blueprint of the data plane further comprises:
assigning, by the processor set, the required software modules to locations on an m×n matrix; and
inputting to the CSP solver, by the processor set, variables defining which of the required software modules share data with others of the required software modules, wherein at least one of the required software modules in the blueprint performs more than one governance action during an execution of the workload.

9. The method of claim 1, further comprising sending, by the processor set, a notification to the client device indicating that the governed data set is available to the workload.

10. A computer program product comprising one or more computer readable storage media having program instructions collectively stored on the one or more computer readable storage media, the program instructions executable to:
receive a data request from a client device in a network, the data request including information regarding one or more governed datasets required by a workload of a user;
identify attributes of available information technology (IT) infrastructure in the network in response to receiving the data request;
generate a blueprint of a data plane for the one or more governed datasets using a Constraint Satisfaction Problem (CSP) solver, the blueprint including required software modules for the workload, a subset of the available IT infrastructure to execute the required software modules, and instructions for a flow of data between the required software modules based on predetermined IT configuration policies;
deploy the data plane in the network based on the blueprint, thereby connecting the workload to the one or more governed datasets by the required software modules executed on the subset of the available IT infrastructure; and
send a notification to the client device indicating that the governed data set is available to the workload.

11. The computer program product of claim 10, wherein one or more of the required software modules of the data plane is configured to perform data transformations of the one or more governed datasets based on predetermined data governance policies.

12. The computer program product of claim 10, wherein the program instructions are further executable to:
provide a user interface enabling a user to define custom information technology (IT) configuration policies for a set of computer resources in a network; and
receive and store custom IT configuration policies of the user indicating what computing capabilities to allow, what computing resources to deploy, and what set of software modules to use to implement the computing capabilities, wherein the predetermined IT configuration policies are the custom IT configuration policies, and the data plane is a custom data plane deployed in accordance with the custom IT configuration policies.

13. The computer program product of claim 10, wherein the program instructions are further executable to monitor IT infrastructure in the network in real time to identify the available IT infrastructure.

14. The computer program product of claim 10, wherein the generating the blueprint of the data plane comprises inputting parameters to the CSP solver including: the available IT infrastructure, available software modules; capabilities of the available software modules; the predetermined IT configuration policies; and stored data governance policies for governance actions taken with respect to the one or more governed datasets.

15. The computer program product of claim 14, wherein the program instructions are further executable to allocate a set of constraint variables for each location in a chain of the required software modules, the set of constraint variables including: an integer for each of the required software modules; an integer for each capability of each of the required software modules to be utilized at each of the locations in the chain; a Boolean per governance action executed by each of the required software modules at each of the locations in the chain; an integer per computational cluster of IT infrastructure where each of the required software modules will run; an integer for each external data storage location storing an output of each of the required software modules; and two integers for each interface configuration to be used in each of the required software modules input and output, wherein the blueprint comprises a linear flow of data through a chain of the required software modules.

16. The computer program product of claim 14, wherein the generating the blueprint of the data plane further comprises:
assigning the required software modules to locations on an m×n matrix; and
inputting to the CSP solver variables defining which of the required software modules share data with others of the required software modules, wherein at least one of the required software modules in the blueprint performs more than one governance action during an execution of the workload.

17. A system comprising:
a processor set, one or more computer readable storage media, and program instructions collectively stored on the one or more computer readable storage media, the program instructions executable to:
receive a data request from a client device in a network, the data request including information regarding one or more governed datasets required by a workload of a user;
identify available information technology (IT) infrastructure in the network via real-time monitoring of IT infrastructure in the network;
identify attributes of the available IT infrastructure in the network;
generate a blueprint of an optimized data plane for the one or more governed datasets using an output of a Constraint Satisfaction Problem (CSP) solver, the blueprint including required software modules for the workload, a subset of the available IT infrastructure to execute the required software modules, and instructions for a flow of data between the required software modules based on predetermined IT configuration policies, wherein the CSP solver provides an output based on optimization goals of the IT configuration policies;
deploy the optimized data plane in the network based on the blueprint, thereby connecting the workload to the one or more governed datasets by the required software modules executed on the subset of the available IT infrastructure; and
send a notification to the client device indicating that the governed data set is available to the workload.

18. The system of claim 17, wherein the program instructions are further executable to:
provide a user interface enabling a user to define custom information technology (IT) configuration policies for a set of computer resources in a network; and
receive and store custom IT configuration policies of the user indicating what computing capabilities to allow, what computing resources to deploy, and what set of software modules to use to implement the computing capabilities, wherein the predetermined IT configuration policies are the custom IT configuration policies, and the optimized data plane is an optimized custom data plane deployed in accordance with the custom IT configuration policies.

19. The system of claim 17, wherein the generating the blueprint of the optimized data plane comprises inputting parameters to the CSP solver including: the available IT infrastructure, available software modules; capabilities of the available software modules; the predetermined IT configuration policies; and stored data governance policies for governance actions to be taken with respect to the one or more governed datasets, wherein an output of the CSP solver is an optimal combination of the required software modules, data flow between the software modules, and IT infrastructure to execute the software modules based on optimization goals of the IT configuration policies.

20. The system of claim 17, wherein the generating the blueprint of the optimized data plane further comprises:
assigning the required software modules to locations on an m×n matrix; and
inputting to the CSP solver variables defining which of the required software modules share data with others of the required software modules, wherein at least one of the required software modules in the blueprint performs more than one governed action during an execution of the workload.
